(19) United States
(12) Patent Application Publication
(10) Pub. No.: US 2005/0041343 A1
(43) Pub. Date: Feb. 24, 2005

(54) Voltage limiting semiconductor pass gate circuit

(76) Inventor: Pradip Mandal, Bangalore (IN)

Correspondence Address: PHILIPS INTELLECTUAL PROPERTY & STANDARDS, P.O. BOX 3001, BRIARCLIFF MANOR, NY, 10510, US

(21) Appl. No.: 10/501,826

(22) PCT Filed: Dec. 12, 2002
(86) PCT No.: PCT/IB02/05484

(30) Foreign Application Priority Data
Jan. 22, 2002 (EP) 02075258.0

(51) Int. Cl. H02H 7/00; H02H 9/00

(52) U.S. Cl. 361/18

(57) ABSTRACT

A voltage limiting scmiconductor pass gate circuit (15), comprises a first transistor (16), operatively connected to an input node (10) and an output node (11) of the pass gate circuit (15), and a second transistor (17), operatively connected between the input node (10) and the output node (11). The second transistor (17) has a control electrode biased to a supply voltage (6), and the first transistor (16) has a control electrode which connects by two back-to-back connected diode elements (18, 19) to the control electrode of the second transistor (17). The pass gate circuit (15) is typically applied in input I/O cells (14) of semiconductor integrated circuits (13).

The invention relates to a voltage limiting semiconductor pass gate circuit, comprising a first transistor operatively connected between an input node and an output node of the pass gate circuit, the first transistor having a control electrode biased to a supply voltage.

In mixed semiconductor technology environments, wherein Integrated Circuits (ICs) of different type are used, some of the ICs have an internal supply voltage lower than that of the other ICs, because the control electrode or gate of the Metal Oxide Semiconductor (MOS) transistors in these ICs can not withstand the higher voltage which is used for the other ICs. Therefore, special care is required in the Input/Output (I/O) cells or circuits which are used in the ICs having the lower internal supply voltage. In particular, the input I/O cells should have a voltage limiting pass gate which protects gate oxide of transistors in a subsequent circuit stage.

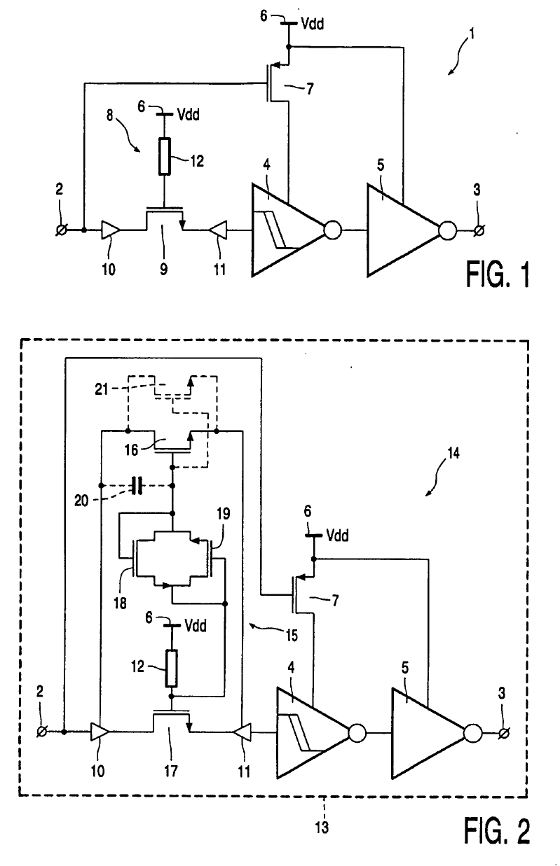

A typical input I/O cell of a digital IC is shown in FIG. 1, and generally designated by reference numeral 1.

The I/O cell 1 comprises an input terminal 2 and an output terminal 3. A level detector circuit 4 is coupled between the input and output terminals 2 and 3, which, in the embodiment shown, is made up as a hysteresis inverter circuit. A further inverter circuit 5 is coupled between the hysteresis inverter 4 and the output terminal 3 of the I/O cell 1.

The further inverter circuit 5 is powered by a supply voltage Vdd, indicated by a short line 6. The hysteresis inverter 4 is coupled to the supply voltage Vdd via a supply transistor 7.

In the embodiment shown, the supply transistor 7 is a PMOS field effect transistor, the drain electrode of which connects to the hysteresis inverter 4 and the source of which connects to the supply voltage 6. The gate or control electrode the supply transistor 7 connects directly to the input terminal 2 of the I/O cell 1.

A voltage limiting transistor pass gate circuit 8 is coupled between the input terminal 2 and the hysteresis inverter 4, and typically comprises an NMOS transistor 9, which operatively connects between an input node 10 and a output node 11 of the transistor pass gate circuit 8.

That is, the drain of the pass transistor 9 connects to the input node 10 and the source of the pass transistor 9 connects to the output node 11. The control electrode or gate of the pass transistor 9 is biased to the supply voltage Vdd via a bias resistor 12.

In the I/O cell 1, the pass transistor 9 limits the high logic level of the circuit within Vdd. This is required to avoid high stress voltage between the gate and source of field effect transistors accommodated in the hysteresis inverter 4.

In DC behaviour, with a high input signal at the input terminal 2 of the I/O cell 1, which input signal may be higher than the supply voltage Vdd, the pass transistor 9 pulls the output node 11 up to Vdd−Vt, wherein Vt is the body effected threshold voltage of the pass transistor 9. The voltage at the output node 11 may be sensed by the hysteresis inverter 4 as a logic high level.

However, this prior art circuit has a number of limitations. In transient behaviour, the output node 11 rises relatively slowly to the voltage Vdd−Vt. That is, if the voltage at the output node 11 becomes closer and closer to Vdd−Vt, the pass transistor 9 approaches its cut off region of operation and hence its current sourcing capability significantly drops. Consequently, it takes a relatively long time for the output node 11 to reach the voltage level VIH of the hysteresis inverter 4 at which a logic high level is detected. The rise delay of the I/O cell is longer than its fall delay.

This situation becomes even worse for high noise immunity requirements, for which the hysteresis inverter 4 needs to have a relatively high hysteresis in its response. With this requirement, VIH of the hysteresis inverter 4 is relatively high, because it should be well above the voltage level VIL at which a logic low is detected plus the hysteresis voltage of the hysteresis inverter 4. It will be appreciated that, with a high noise immunity requirement, the rise delay of the I/O cell 1 is further increased.

Although not explicitly explained above, the transistor 7 operates to limit the supply voltage of the hysteresis inverter 4 and to stop a leakage current, as its gate voltage is above Vdd during DC condition with a high input level.

It is an object of the present invention to provide an improved voltage limiting pass gate circuit, which can be used for high speed and high noise immunity input I/O cells, with improved, i.e. shorter, rise delay times compared to the prior art transistor pass gate circuit disclosed above.

To this end, according to the invention, the control electrode is biased to the supply voltage by two back-to-back connected diode elements. This results in a pass gate circuit having improved transient properties in comparison to the prior art circuit.

In an embodiment, the semiconductor pass gate circuit further comprises a second transistor being operatively connected between said input node and said output node, the second transistor having a further control electrode coupled to the control electrode of the first transistor via the two back-to-back connected diode elements.

That is, in the pass gate circuit according to the present invention, the pass transistor is splitted into two parts i.e. a first transistor and a second transistor, the control electrodes of which are connected via two back-two-back connected semiconductor diode elements.

With the improved transistor pass gate circuit according to the present invention, a pre-charging of inherent capacitors of the transistors, in particular of the first transistor, is achieved which improves the transient properties of this pass gate circuit.

In a preferred embodiment of the pass gate circuit according to the present invention, the diode elements are comprised of diode connected transistors, which may be of a same or different conductivity type. All the transistors of the circuit may be of the same conductivity type and are preferably MOS-type field effect transistors.

It is noted that, when the first and second transistor are replaced by the single transistor, the dimensions or sizes of this single transistor have to be appropriately increased compared to the first transistor, in order not to increase the fall delay of the circuit.

The invention further relates to an input I/O cell for use with an integrated semiconductor circuit, having a input terminal and an output terminal and at least one level detector circuit connected between the input terminal and the output terminal, wherein semiconductor pass gate circuit as disclosed above is connected between the input terminal and the level detector circuit.

In a preferred embodiment of the input I/O cell according to the present invention, the level detector circuit comprises a hysteresis circuit.

If the hysteresis circuit is a hysteresis inverter circuit, a further inverter circuit may be connected between the hysteresis inverter and the output terminal of the I/O cell.

The invention also relates to an integrated circuit comprising at least one input I/O cell in accordance with the present invention.

The invention will now be disclosed in more detail with reference to the accompanying drawings, in which:

FIG. 1 is a schematic representation of a prior art input I/O cell; and

FIG. 2 is a schematic representation of an input I/O cell in an embodiment of the present invention.

In the Figs, parts or elements having like functions or purpose bear the same reference numerals.

FIG. 2 shows an input I/O cell 14, having an improved voltage limiting semiconductor pass gate circuit 15 according to the present invention.

Compared to the prior art pass gate circuit 8 as shown in FIG. 1 and discussed above, the pass transistor 9 thereof has been splitted into a first pass transistor 16 and a second pass transistor 17, both operatively connected between the input node 10 and the output node 11 of the pass gate circuit 15.

In the embodiment shown, the first and second pass transistors 16, 17 are of the NMOS type, wherein the drains of the transistors 16, 17 connect to the input node 10 and the sources of the pass gate transistors 16, 17 connect to the output node 11 of the pass gate circuit 15, respectively. It will be obvious to those skilled in the art that other transistor types can be chosen without departing from the scope of the present invention.

Via two back-to-back or counter parallel diode connected transistors 18, 19, the control electrode or gate of the first pass transistor 16 connects to the control electrode or gate of the second pass transistor 17.

For zero voltage or near zero voltage at the input terminal 2 of the I/O cell 14, corresponding to a low logic level, the gate-to-source capacitor 20, indicated in dotted lines, of the first pass transistor 16 is charged to Vdd−Vt volts via the diode connected transistor 19.

If the voltage at the input terminal 2 of the I/O cell 14 now rises to a high logic level, the rising edge at the input terminal 2, i.e. the input node 10 of the pass gate circuit 15, passes through the capacitor 20 to the gate of the first pass transistor 16 and forces the diode connected transistor 19 in its cut off region. The diode connected transistor 18 clamps the gate voltage of the first pass transistor 16 at Vdd+Vt. This helps the first pass transistor 16 to pull the output node 11 of the pass gate circuit 15 up to Vdd.

It is important to note that, although the diode connected transistor 18 finally clamps the gate voltage of the first pass transistor 16 at Vdd+Vt, a positive ripple in the transient gate voltage is allowed. The strength of the ripple can be controlled by properly sizing the diode connected transistor 18. This positive ripple aids the voltage at the output node 11 to strongly follow the rising edge at the input node 10, until it reaches Vdd.

On the other hand, similar to the single pass transistor 9 in the prior art pass gate circuit 8 shown in FIG. 1, the second pass transistor 17 passes a clear low level from the input node 10 to the output node 11 of the pass gate circuit 15.

By using the improved pass gate circuit 15 according to the present invention in an I/O cell 14, the voltage at the input of the hysteresis inverter 4 strongly follows the input voltage at the input terminal 2 of the I/O cell 14, even for a relatively large hysteresis in the hysteresis inverter 4. Consequently, the rise and fall delays of VO cell 14 become relatively small and nearly symmetric.

In tables 1 and 2 below, the simulated performance of the I/O cell 14 in accordance with the present invention is compared with the simulated performance of the prior art I/O cell 1.

TABLE 1
Simulated performance comparison for hysteresis 0.3 V

| | I/O cell with | I/O cell with |
|---|---|---|
| Performance | existing pass gate | new pass gate |
| Rise delay (psec) | 1197 | 467 |
| Fall delay (psec) | 502 | 516 |
| Rise time (psec) | 389 | 351 |
| Fall time (psec) | 357 | 356 |
| Max. frequency (MHz) | 350 | 650 |

TABLE 2
Simulated performance comparison for hysteresis > 0.4 V

| | I/O cell with | I/O cell with |
|---|---|---|
| Performance | existing pass gate | new pass gate |
| Rise delay (psec) | Undefined | 589 |
| Fall delay (psec) | 501 | 511 |
| Rise time (psec) | Undefined | 368 |
| Fall time (psec) | 361 | 359 |
| Max. frequence (MHz) | Undefined | 625 |

From the simulation results it directly follows that for moderate noise immunity requirements, i.e. table 1 hysteresis 0.3 V, the input I/O cell in accordance with the present invention is at least 1.8 times faster with respect to the rise delay compared to the prior art input I/O cell.

For high noise immunity requirements, i.e. hysteresis >0.4V, table 2, it can be seen that while the input I/O cell with the prior art pass gate circuit fails to function, the input I/O cell with the improved semiconductor pass gate circuit according to the present invention continues to perform well.

In a further embodiment of the pass gate circuit 15 according to the invention, the first and second transistor 16, 17 are replaced by a single transistor 21, shown in FIG. 2 by dotted lines, and having a control electrode or gate which is biased to the supply voltage 6 by the back-to-back connected diode elements 18, 19. Removal of the second transistor 17 may, however, increase the fall delay, which can be recovered by increasing the size or dimensions of the single transistor 21 compared to those of the first transistor 16.

Those skilled in the art will appreciate that with very little additional silicon area, i.e. just to the expense of three additional transistors, e.g. diode transistors 18 and 19 and single transistor 21, a remarkable improvement of the transient behaviour of input I/O cells an be achieved.

An IC having one or a plurality of input I/O cells in accordance with the present invention is schematically indicated in dotted lines and bearing reference numeral 13.

Those skilled in the art will appreciate that MOS transistors are perfectly bidirectional, i.e. their drain and source are interchangeable and are defined on the basis their relative voltages. Accordingly, in the above disclosure of the present invention, the terms source and drain should not be construed as a limitation to the specific circuit connections of MOS transistors, and the invention is not limited to the use of NMOS transistors shown, but can be likewise realised with PMOS transistors or a mixture of NMOS and PMOS transistors.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A voltage limiting semiconductor pass gate circuit (15), comprising a first transistor (16, 21) being operatively connected between an input node (10) and an output node (11) of said pass gate circuit (15), the first transistor (16, 21) having a control electrode being biased to a supply voltage (6), characterized by the control electrode being biased to the supply voltage (6) by two back-to-back connected diode elements (18, 19).

2. A semiconductor pass gate circuit (15) according to claim 1, wherein said diode elements (18, 19) are comprised of diode connected transistors.

3. A semiconductor pass gate circuit (15) according to claim 1, wherein the semiconductor pass gate circuit (15) further comprises a second transistor (17) being operatively connected between said input node (10) and said output node (11), the second transistor (17) having a further control electrode coupled to the control electrode of the first transistor (16) via the two back-to-back connected diode elements (18, 19).

4. An input I/O cell (14) for use with integrated semi-conductor circuits, said I/O cell (14) having an input terminal (2), an output terminal (3) and at least one level detector circuit (4) coupled between said input terminal (2) and said output terminal (3), characterized by a semiconductor pass gate circuit (15) in accordance with claim 1, coupled between said input terminal (2) and said level detector circuit (4).

5. An input I/O cell (14) according to claim 4, wherein said level detector circuit comprises a hysteresis circuit (4).

6. An input I/O cell (14) according to claim 5, wherein said hysteresis circuit (4) is hysteresis inverter circuit.

7. An input I/O cell (14) according to claim 6, wherein a further inverter circuit (5) couples said hysteresis inverter circuit (4) to said output terminal (3).

8. An integrated circuit (13) compromising at least one input I/O cell (14) in accordance with claim 4.
